(19) United States
(12) Patent Application Publication
(10) Pub. No.: US 2021/0069834 A1
(43) Pub. Date: Mar. 11, 2021

(54) METHOD, DEVICE, AND SYSTEM FOR PROTECTING A TOUCH SCREEN

(71) Applicant: Curio Holding Company, Philadelphia, PA (US)

(72) Inventors: Dennis O'Donnell, Philadelphia, PA (US); Eric Griffin-Shelley, Philadelphia, PA (US)

(21) Appl. No.: 17/015,422

(22) Filed: Sep. 9, 2020

Related U.S. Application Data
(60) Provisional application No. 62/898,833, filed on Sep. 11, 2019.

(51) Int. Cl. B23K 26/38; G06F 1/16; C09J 7/25; G06F 3/041

(52) U.S. Cl. CPC B23K 26/38; G06F 1/1626; G06F 3/041; C09J 7/25; G06F 1/1607

(57) ABSTRACT

Methods, devices, and systems are disclosed for producing a screen protector. In one embodiment, a method includes receiving a multi-layered sheet into a cutting device, the cutting device configured to provide different cut types. A characteristic of the sheet received into the cutting device is determined. Based thereon, a cut type is determined. The sheet is cut according to the determined cut type to form the screen protector. Further, a charge for the cutting of the sheet is determined based on the cut type.

### CROSS REFERENCE TO RELATED APPLICATIONS

The present application claims the benefit of U.S. Provisional Patent Application No. 62/898,833 filed on Sep. 11, 2019, which is incorporated herein by reference in its entirety.

### BACKGROUND

Touch screens are widely used, including in portable electronic devices, such as cellular telephones and portable computing devices. A factor owing to the popularity of these electronic touch screen devices is their portability. The devices are generally lightweight and/or compact. As a result, users often carry and use these electronic devices when traveling or when participating in daily activities. In many cases, the touch screens of these electronic devices come in contact with other objects and may become scratched. In the case of smartphones, a user may place the phone in the user's pocket or purse along with potentially other sharp items, such as, for example, keys, nail files, key chains, coins, pens and other objects. Consequently, there is a need to protect the screens of these electronic devices from scratching or other breakage.

Conventionally, film that is placed on the screen surface has been used to protect the surface of the screen. This film can be cut to fit the specific dimensions of the device being protected. A problem arises, however, when different types of film are offered for use with a device. Different films require different types of cuts. For example, a thicker film requires a slower and more forceful cut. There is need for a system that ensures the proper cut is applied to the film being used. There is also need for a system that invoices users of the cutter based on the types of cuts being used.

### BRIEF SUMMARY

Methods, devices, and/or systems may be provided for protecting a display. For example, a multi-layer screen protector may be provided. The screen protector may include a top layer, a bottom layer, and an adhesive layer that couples (e.g., adheres) the top/bottom layers with a mobile device. The adhesive layer may include an adhesive. The adhesive may be a pressure sensitive adhesive. The adhesive that forms the adhesive layer may be a non-reactive adhesive, for example, that forms a bond when pressure is applied to bond the adhesive to one or more layers and/or other surfaces. The adhesive may be an adhesive that is not self-wetting. The adhesive may be formed of a plastic material, such as acrylic. The adhesive may provide weathering (e.g., water-resistant, water-proof) properties.

Methods, devices, and systems may be provided for producing a screen protector. The screen protector may protect the display of a device, such as a mobile device. An example method includes inserting a sheet into a cutting device (e.g., a cutting plotter), determining the thickness of the sheet inserted into the cutting device, cutting, via the cutting device, the sheet, and/or forming a screen protector using the sheet. The sheet may include at least two layers, which may include an adhesive layer. The adhesive layer may be formed of an acrylic material.

Methods, devices, and systems may be provided for determining (e.g., automatically determining) a cost of a screen protector. The cost of the screen protector may be based on characteristics of the sheet forming the screen protector. The cost of the screen protector may be based on a cost of the sheet forming the screen protector and/or a cost of a cut of the sheet forming the screen protector. For example, different cuts may be defined for different characteristics of sheets. A retailer selling the screen protector may be charged different amounts (e.g., different cut amounts) based on characteristics of the sheet forming the screen protector. Sheet characteristics may include an identity of the sheet to be cut, the thickness of the sheet to be cut, a hardness of the sheet to be cut, a type of the sheet to be cut, etc.

The cost of the cuts for the sheets may be provided remotely, for example, by a party (e.g., lessor, seller) that leases or sells the cutting plotter to a retailer. As an example, a lessor may define (e.g., remotely define) that the retailer pay an amount for a cut relating to a standard sheet. The lessor may define that the retailer pay a different amount (e.g., a greater amount) for a cut relating to a premium sheet. The lessor may define (e.g., remotely define) that the retailer pay more for cutting a thicker sheet than for cutting a thinner sheet. The thickness of the sheet may be determined automatically (e.g., via the electronic controlling device and/or cutting plotter), in some examples. In other examples, the thickness of the sheet may be determined via the user of the electronic controlling device and/or cutting plotter and provided to the electronic controlling device and/or cutting plotter.

Methods, devices, and systems may be provided for generating and/or providing an invoice. The generated invoice may include the costs to the retailer. For example, the costs to the retailer may include the costs of the sheets, the costs of cutting the sheets, and/or the costs of leasing or purchasing the electronic controlling device and/or cutting device. A retailer may receive one or more invoices that include the costs of the sheets, the costs of cutting the sheets, and/or the costs of renting or purchasing the electronic controlling device and/or cutting device.

In one aspect, a method includes receiving a sheet into a cutting device, the cutting device configured to provide different cut types, and the sheet comprising an adhesive layer and at least one other layer; determining a characteristic of the sheet received into the cutting device; determining, based on the determined characteristic of the sheet, a cut type from among the different cut types; cutting the sheet according to the determined cut type to form a screen protector; and determining a charge for the cutting of the sheet based on the determined cut type.

In another aspect, a system includes, a cutting device configured to receive a sheet and to provide different cut types, wherein the received sheet comprises an adhesive layer and at least one other layer; one or more processors configured to determine a characteristic of the sheet received into the cutting device; determine, based on the determined characteristic of the sheet, a cut type from among the different cut types; instruct the cutting device to cut the sheet according to the determined cut type to form a screen protector; and determine a charge for the cutting of the sheet based on the determined cut type.

In another aspect, a non-transitory computer-readable storage medium encoded with instructions which, when executed on a processor, performs a method of determining a characteristic of a sheet received into a cutting device, the cutting device configured to provide different cut types, and the sheet comprising an adhesive layer and at least one other layer; determining, based on the determined characteristic of the sheet, a cut type from among the different cut types; cutting the sheet according to the determined cut type to form a screen protector; and determining a charge for the cutting of the sheet based on the determined cut type.

### BRIEF DESCRIPTION OF THE DRAWING

FIG. 1 is a side elevation view of an example screen protector film, as described herein.

FIG. 2 is an example process of determining characteristics of a multilayer screen protector and cutting the screen protector accordingly, as described herein.

FIG. 3 is an example system for determining costs of a screen protector based on characteristics of the sheets forming the screen protector.

### DETAILED DESCRIPTION

The following description is merely exemplary in nature and is in no way intended to limit embodiments of the invention, their applications, or uses. As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features, the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” means less than about 0.1 wt. % based on the total of the referenced value.

Features of the present inventions may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIPTM drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

### Screen Protector

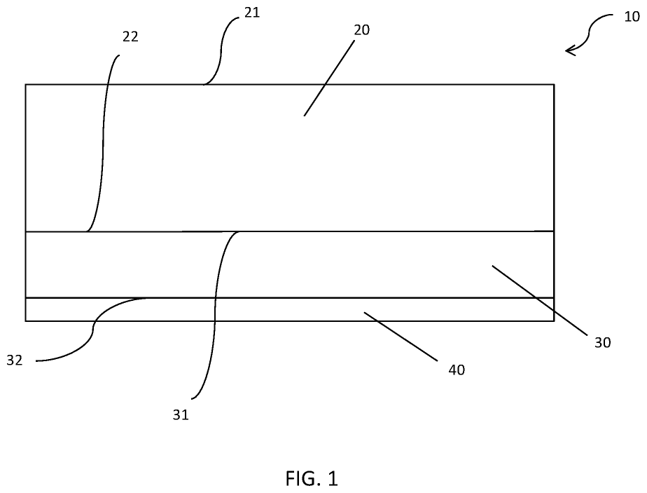

Referring to FIG. 1, a multilayer screen protector 10 is shown having a top layer 20, a bottom layer 30 and an adhesive layer 40. The top layer has a top surface 21 and a bottom surface 22. The bottom layer 30 has a top surface 31 and a bottom surface 32. The adhesive layer 40 may be provided on the bottom surface 32 of the bottom layer 30. The adhesive layer 40 may be thicker than the top layer and/or the bottom layer (e.g., only thicker than the bottom layer). Although FIG. 1 shows three layers, in other examples the screen protector may have more, or less, layers. The multilayers may be combined to form a single sheet.

The adhesive layer 40 may include an adhesive that may provide a suitable adhesion of the screen protector to a display surface and/or may allow the screen protector 10, once installed on the surface of a display, to be removed and reinstalled. The screen protector 10 may be constructed as a planar structure.

The adhesive that forms the adhesive layer 40 may be a pressure sensitive adhesive. The adhesive that forms the adhesive layer 40 may be an adhesive that is not self-wetting. For example, the adhesive (e.g., the adhesive that is not self-wetting) may require additional steps to create a bubble-free installation and/or may aid to create a bubble-free installation. As an example, a fluid may be used in applying the adhesive to ensure a bubble-free application of the adhesive. As another example, heat may be applied to the adhesive (e.g., the adhesive that is not self-wetting) and/or the heat would be used to soften the adhesive (e.g., to aid the adhesive in wetting out). The adhesive may be a pressure sensitive adhesive. As a pressure sensitive adhesive, the adhesive may be a non-reactive adhesive and/or may form a bond when pressure is applied to bond the adhesive to one or more of the layers and/or to one or more other surfaces (such as the surface of the mobile device).

The adhesive may be formed of a plastic material, such as an acrylic material. The acrylic adhesive may be a resin-based adhesive that may be comprised of acrylic or methyl acrylic polymers. The acrylic adhesive may be self-wetting or may not be self-wetting. The adhesive may be a foam (e.g., acrylic foam) adhesive. In examples in which the adhesive is a foam adhesive, the adhesive may have self-wetting properties. The adhesive may be thick and have a foam texture (e.g., to aid in impact absorption). The acrylic adhesive may perform an aggressive bonding, for example, that may be more aggressive than silicone-based adhesives. The material (e.g., acrylic material) forming the adhesive may provide strength, rigidity, and/or optical clarity to the adhesive layer 40. The adhesive (e.g. acrylic adhesive) may provide weathering (e.g., water-resistant, water-proof) properties to the screen protector.

The top layer 20 may be made of urethane (e.g., polycaprolactone aliphatic urethane (PAU)), the bottom layer 30 may be made of a plastic (e.g., polyethylene terephthalate). The adhesive (e.g., adhesive layer 40) may be provided on the bottom surface 32 of the bottom layer 30.

The screen protector 10 may be applied to a screen display surface in the presence of dirt or dust on the screen display. Dust and dirt are components common to a number of environments, such as, for example, on the military fields of operations, in factories, outdoor environments, sporting events (e.g., fields and tracks). There may not be the resources, time, or facilities by which to remove the dust, dirt, fingerprints and other interfering items that may be present on the screen display prior to installation of a screen protector. The screen protector 10 may include a layer 40 that consists of an adhesive that may not be self-wetting. The adhesive may be used to attach (e.g., adhere) to the display surface to promote the attachment of the protector 10 onto a display screen.

The screen protector 10 may have a top layer 20 that is a protective layer that resists abrasion and provides increased resistance to harsh environments and high-wear conditions. The screen protector 10 has a top layer 20 that may be made from urethane, such as from polycaprolactone aliphatic urethane (PAU), which is a highly abrasive-resistant material. According to a preferred embodiment, the PAU top layer may have a thickness of from 1 mil to 8 mil (0.0254 mm to 0.2032 mm). The polycaprolactone aliphatic urethane layer 20 may be thin and/or may be supported by the bottom layer 30.

The screen protector bottom layer 30 may represent the structural layer that may support the polycaprolactone aliphatic urethane layer 20. The illustration in FIG. 1 shows an example polycaprolactone aliphatic urethane layer 20 supported directly on the bottom layer 30. The bottom layer 30 may be a hard plastic structural layer which is constructed from a rigid plastic material and/or which may be constructed from a plastic material, such as, for example, a hard clear plastic from plastic materials selected from the group consisting of acrylic and polystyrene. In an example the bottom layer 30 may be made of polyethylene terephthalate. In a preferred embodiment the bottom layer 30 may have a thickness of about 3 mils. The bottom layer 30 having such a thickness provides certain advantages. For example, in the cutting of one or more layers (including the bottom layer 30) of the screen protector., the combination of the bottom layer 30 being relatively thin (e.g., having a thickness of 3 mils), and a thicker acrylic adhesive layer, allows for clean, straight cuts without need for a laser. Further, the relative thinness of the bottom layer 30 may offset the relative thickness of the adhesive layer, resulting in a thin screen protector. In examples, however, the thickness of the bottom layer 30 may be greater than 3 mils or less than 3 mils.

The bottom layer 30 and top layer 20 may be coupled to one another. The top layer 20 and bottom layer 30 may be co-extruded, for example, so that the layers 20, 30 form a multi-layer laminate layer. The multi-layer laminate formed from the two layers may include the top surface 21 (e.g., an abrasive resistant polycaprolactone aliphatic urethane surface) on the top polycaprolactone aliphatic urethane layer 20, and the bottom surface 32 that may be the plastic surface of the plastic bottom layer 30. The hard plastic bottom layer 30 may provide suitable rigidity for the screen protector 10. The polycaprolactone aliphatic urethane surface 21 and the polycaprolactone aliphatic urethane top layer 20 may be supported by the rigid plastic bottom layer 30. The laminate formed consisting of the polycaprolactone aliphatic urethane top layer 20 and plastic bottom layer 30 may have the abrasion resistant top surface 21 and the supportive bottom layer 30. The top layer 20 may be a thin layer of polycaprolactone aliphatic urethane and may provide abrasion resistance and optical clarity as a uniform layer in conjunction with the supporting structure, which may be the plastic bottom layer 30, that may be a uniform layer, so that the screen protector 10 is a film having excellent optical clarity qualities as well as superior abrasion resistance.

The securing together of the top layer 20 and bottom layer 30 may be accomplished to maintain the optical clarity of the laminate. For example, a laminate of coextruded polycaprolactone aliphatic urethane and rigid plastic may be formed having optically clear properties, to which the adhesive layer 40 is applied to form the screen protector 10. The top layer 20 and bottom layer 30 are secured together without an additional component between the layers. According to an alternate embodiment, a bonding agent or adhesive may be used to accomplish the lamination of the top layer 20 and the bottom layer 30. A high tack aggressive adhesive, such as, for example, acrylic adhesives, may be used in order to bond the top layer 20 to the bottom layer 30. In this example, the aggressive adhesive secures the bottom surface 22 of the top layer 20 to the top surface 31 of the bottom layer 30. According to an embodiment, the top layer, such as, for example, the layer of polycaprolactone aliphatic urethane, may be provided with an aggressive, high tack adhesive thereon, on the bottom surface 22. A lamination process may be used to adhere the polycaprolactone urethane layer 20 to the bottom layer 30.

The screen protector 10 may consist of a coextruded polycaprolactone aliphatic urethane top layer 20 and a plastic bottom layer 30 secured together to form a film, the film having structural rigidity and having a durable, clear and abrasion-resistant surface 21. The plastic layer may be a hard layer and/or may be a poor abrasion protection agent. The plastic layer provides structural support for the polycaprolactone aliphatic urethane layer. The formed laminate screen protector 10 may be a planar structure suitable for installation on a flat surface. The construction of the layers and the film 10 provides an optically clear and uniform abrasion resistant surface. The present screen protector 10 is abrasion resistant and may be readily installed on a display screen in almost any environment and without the need for tools.

The adhesive layer 40 is applied on the bottom surface 32 of the bottom layer 30 to form the screen protector 10. The adhesive may not be a self-wetting adhesive, as described herein. The adhesive may be applied by any suitable method for applying adhesives to a surface

The screen protector 10 may be attached to a display with the adhesive. The adhesive may provide the ability to remove and replace the screen protector 10 on a display without the need to remove the adhesive from the surface of the screen display. The adhesive may not be applied to the polycaprolactone aliphatic urethane top layer 20. The adhesive may be applied to the hard plastic structural layer, the bottom layer 30, which may be a polystyrene or acrylic layer or a PET layer. According to an embodiment, the adhesive 40 may be applied to the bottom layer surface 32 of the structural or bottom layer 30 and the structural layer 30 may be connected to the top layer 20 through a co-extrusion process. According to another embodiment, the structural layer 30 may be connected to the top layer 20 through a co-extrusion process, and the adhesive layer 40 may be applied to the bottom layer surface 32.

The screen protector 10 may be applied to one or more display surfaces, for example, to prevent abrasion. The screen protector 10 provides resistance to scratching and allows for improved ease of installation. The construction of the screen protector 10 may provide remedial solutions for improper installation or errors, in that the adhesive composition and placement in conjunction with the bottom layer 30 remains active for reinstallation or repositioning of the screen protector 10 on a screen display.

### Cutting Device

One or more of the layers (e.g., all of the layers) described herein may be cut, shaped, etc., via a cutting device. The cutting device may be a cutting plotter, such as a vinyl cutting plotter. For example, in view of the unique composition of the film, the cutting plotter may cut film, even thicker films, using a mechanical cutter rather than a laser. The layers (e.g., all of the layers) may be combined to form a sheet (e.g., a single sheet). For example, one or more of the layers (e.g., top layer 20, bottom layer 20, adhesive layer 40, etc.) may be cut via the cutting plotter. Properties of one or more of the layers may assist in the cutting of the sheet. For example, as described herein the adhesive layer 40 may be formed of an acrylic material. The acrylic adhesive layer 40 may be thick (e.g., thicker, as compared to other adhesives and/or other layers such as adhesive layer). The thickness of the acrylic (e.g., adhesive layer) may assist in the cutting of the sheet. The sheet (e.g., layers forming the sheet) may be cut to fit a screen protector to a predefined mobile device, such as a smart phone. The cutting device (e.g., cutting plotter) may be connected to an electronic controlling device having a processor and software. In non-limiting examples the electronic controlling device may be a desktop, laptop, tablet, or other mobile device.

### Controlling Device and Invoicing System

The electronic controlling device and/or the cutting device (e.g., cutting plotter) may be used to cut one or more layers of a sheet, as described herein. The sheet may be cut to fit a screen protector of a mobile device, back protector of a mobile device, and/or body skin of a mobile device, such as a smart phone, tablet, laptop, etc. The sheet may be cut on demand and may be personalized for a particular mobile device. The electronic controlling device, the cutting device, and/or the remote processing device may comprise (together or separately) one or more processors and/or circuits for carrying out the steps described herein for cutting a sheet to form a screen protector and determining a charge for the cutting.

Software may enable the electronic controlling device and/or the cutting plotter to cut one or more of the sheets (e.g., layers of the sheets) to fit a screen protector, back protector, and/or body skin to one or more mobile devices. The sheets may have different characteristics, which may include, for example, a thickness, hardness, type, and/or other properties of the sheet. The cutting plotter may cut the sheet according to a predefined cut type which may be based on the characteristics of the sheet. The software may enable an invoicing system whereby a user of the electronic controlling device and/or cutting plotter may be charged for a (e.g., each) cut performed by the cutting plotter. The user of the electronic controlling device and/or cutting plotter may be charged different prices based on the characteristics of the sheet to be cut. The user of the electronic controlling device and/or cutting plotter may include a retailer of the screen protector, a manufacturer of the screen protector, a consumer of the screen protector, etc.

As described herein, a cost of the sheet and/or a cost of a cut of the sheet may be based on characteristics of the sheet. For example, a retailer may pay different cut amounts based on characteristics of the sheet, including an identity of the sheet to be cut, the thickness of the sheet to be cut, a hardness of the sheet to be cut, a type of the sheet to be cut, etc. For example, the retailer may pay an amount for a cut relating to a standard sheet. The retailer may pay a different amount (e.g., a greater amount) for a cut relating to a premium sheet. A retailer may pay more for cutting a thicker sheet than for cutting a thinner sheet. The retailer may lease, purchase, rent, and/or license the electronic controlling device and/or cutting plotter. In such an example the retailer may pay an amount for the leasing, purchasing, renting, and/or licensing of the electronic controlling device and/or cutting plotter.

An invoice may be generated that includes the costs to the retailer. For example, the costs to the retailer may include the costs of the sheets, the costs of cutting the sheets, and/or the costs of renting or purchasing the electronic controlling device and/or cutting device. As described herein, the costs to the retailer may be based on characteristics of the sheet to be cut. The retailer may receive an invoice (e.g., a separate invoice) that includes the costs of the sheets, the costs of cutting the sheets, and/or the costs of renting or purchasing the electronic controlling device and/or cutting device.

The software may be resident on the electronic controlling device, resident on the cutting plotter, and/or accessible by one or more of the electronic controlling device and/or cutting plotter. In examples the software may be resident on a server, such as a cloud server.

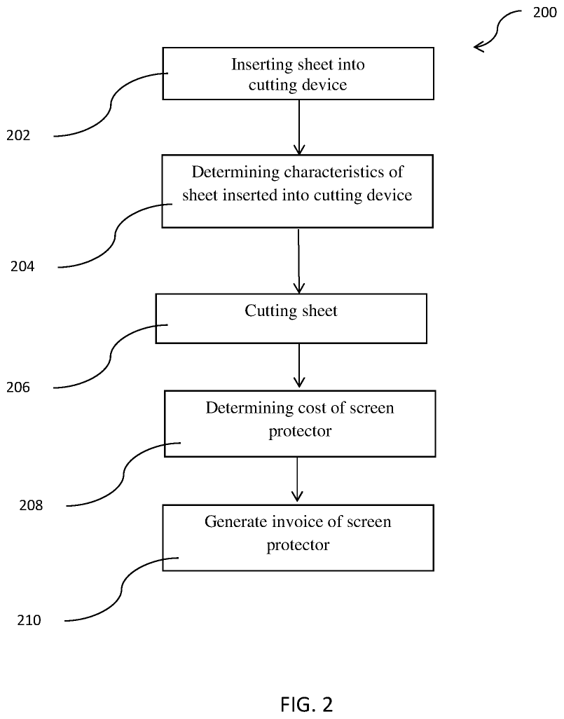

The software may perform an example process 200 (FIG. 2) for cutting one or more layers and/or sheets to fit to a mobile device, as described herein. Process 200 may include generating an invoice for a user (e.g., a retailer) of the electronic controlling device and/or cutting plotter. One or more of the steps outlined in the process 200 may be performed. The process 200 may be performed in any order, and/or by one or more devices. In examples some of the steps may be omitted and in other examples steps may be added.

At 202, a sheet may be inserted into a cutting plotter. The sheet may be used for forming a screen protector. The sheet may include one or more characteristics, such as a thickness, a hardness, a type, an identity, etc. The sheet may include one or more (e.g., all) of the layers described herein. The sheet may be a standard size sheet. For example, sheets (e.g., all sheets inserted into the cutting plotter) may be sized the same. One or more sheets may have a different thickness and/or composition than one or more other sheets.

At 204, the characteristic (e.g., thickness) of the sheet fed into the cutting plotter may be determined. For example, although sheets (e.g., all sheets) may be sized the same (e.g., have the same length and width), one or more types of sheets may be thicker or thinner than one or more other types of sheets. A thicker sheet may provide additional protection (e.g., protection against abrasion) than a thinner sheet. A thicker sheet may provide a more robust feel, etc.

The characteristic (e.g., thickness) of the sheet may be determined based on an identity of the sheet and/or a type of the sheet. One or more layers of the sheet may determine the thickness of the sheet. For example, a sheet may be thicker and/or thinner than another sheet based on (e.g., solely based on) the bottom layer. In such an example, the top layer and the adhesive layer of a sheet may be the same thickness as the top layer and the adhesive layer of another sheet.

In an example, the characteristics of the sheet (e.g., the thickness of the sheet) may be determined and/or identified by the user of the cutting plotter. In such example the user may provide the characteristics of the sheet to the cutting plotter via a user interface. In another example, the characteristics of the sheet may be determined (e.g., automatically determined) via the cutting plotter determining the identity of the sheet and/or the thickness of the sheet that is fed into the cutting plotter and/or the electronic controlling device determining the identity of the sheet and/or the thickness of the sheet that is fed into the cutting plotter. The cutting device may determine characteristics of the sheet based on indicia present on the sheet and sensed by a sensor of the cutting plotter and/or other device. The cutting device may determine characteristics of the sheet via an optical sensor measurement of the thickness of the sheet, by a pinching of mechanisms of the cutting device, etc.

At 206 the sheet may be cut. As described herein, the characteristic of the sheet may determine the cut type to be performed on the sheet. For example, the cutting plotter may cut the sheet based on the thickness and/or composition of the material of the sheet. As an example, the cutting plotter may cut (e.g., be programmed to cut) a thicker sheet more slowly and/or with more force than the cutting plotter may cut a thinner sheet. Accordingly, the cutting plotter may cut a thinner sheet more quickly and/or with less force than a cutting plotter may cut a thicker sheet. The sheet may be cut based on instructions provided by the electronic controlling device. For example, the sheet may be cut based on a template provided by the electronic controlling device. The cutting plotter may adjust one or more of the blades (e.g., distances of the blades, orientations of the blades, etc.) of the cutting plotter to cut the sheet, for example, based on the thickness of the sheet.

The cutting plotter may be prevented from performing a cut that is inconsistent (e.g., improper) with regard to a characteristic (e.g., a thickness) of the sheet fed into the cutting plotter. Preventing the cutting plotter from performing an improper cut to a particular sheet may be beneficial in examples where the user is being charged on a per-cut basis. For example, the cutting plotter may be prevented from performing a cut where, for example, the user is attempting to perform a less expensive cut on a thicker (e.g., more expensive) sheet. By preventing the cutting plotter from performing a cut that is inconsistent with the sheet fed into the cutting machine, an accurate billing of the cutting of the sheet may be determined (e.g., automatically determined). In addition to ensuring proper payment for the cut, preventing the cutting plotter from performing an improper cut to a sheet may assist in ensuring the quality of the cut and/or the film (e.g., final film) provided to the customer, as described herein.

At 208, the cost of the screen protector may be determined. As described herein, the cost of the screen protector may be based on the cost of the sheet and the cost of cutting the sheet.

The determined characteristic of the sheet may be used to determine the cost of a screen protector. For example, the cost (e.g., the cost to a retailer) of providing a screen protector may be based on the material (e.g., material of the sheet) used for the screen protector and/or the cost for cutting the sheet forming the screen protector. For example, a party (e.g., an owner or a lessor) may transfer ownership and/or control of the cutting device to a retailer. Using such example, a lessor of a cutting device may charge $2 to a retailer for purchase of the sheet and $8 to the retailer for the cutting of the sheet. Using this price model, the lessor may alter its pricing—even after the sheets have been sold to the retailer—by altering a cost for the cutting of the sheet. The lessor may alter its pricing by updating (e.g., automatically updating) the cost of the cut, via the software. The cost of cutting the sheet may be based on one or more characteristics of the sheet, as described herein. Although lessor is used throughout the disclosure, this is a non-limiting example of a party that retains some control over a user (such as a retailer) of the cutting device in such a manner that the party can charge an amount to the user for the cutting of the sheets.

Based on the above, the software may be programmed to charge different amounts for the different cuts appropriate for the different types of sheets. The different amounts may be altered at any time, for example, via a remote server. The cost for the cutting of the sheet may be updated periodically (e.g., daily, weekly, monthly, etc.). The cost for the cutting of the sheet may be updated aperiodically (e.g., based on market conditions, a release of a new mobile device, etc.). As a result, the lessor of the machine may have flexibility in pricing, for example, by being capable of increasing and/or decreasing (e.g., remotely increasing and/or decreasing) the amounts received for the cuts. The lessor may (e.g., may also) promote quality by ensuring the correct types of cuts are used for each of the sheets. Further, the model enables the lessor to receive revenues based on a service (e.g., cutting the sheet). This revenue can be in addition to, or alternative to, the cost of leasing the cutting plotter and/or of selling the sheet (e.g., material forming the sheet).

At 210, an invoice for the screen protector may be generated and/or provided. The invoice of the screen protector may be determined using the determined costs, as described in 208. For example, an invoice may be provided (e.g., automatically provided) that is particular to a cost of a cut associated with a screen protector having a defined characteristic (e.g., thickness). The invoice may be generated remotely, for example, by an electronic device. The invoice may be generated and/or sent (e.g., sent to a retailer) periodically, aperiodically, etc.

The invoice may provide an identification of the screen protector, an identification of the thickness of the screen protector, the layers (e.g., the number of layers, the composition of the layers, etc.) that make up the screen protector, the types and/or numbers of cuts used for the screen protector, the costs of the screen protector (e.g., costs of the material used for the screen protector, costs of the cuts used for the screen protector, costs of renting/leasing the electronic controlling device and/or cutting device), etc. The invoice may include the price structure for cutting the sheets, such as prices based on thicknesses of the sheets, compositions of the sheets, etc. For example, the invoice for a thin screen protector may include a cost that is less than a cost of a thicker screen protector, as the cost of the material for the thin screen protector may be less than the thicker screen protector and the cost of cutting the material for the thin screen protector may be less than for cutting the material for the thicker screen protector.

The invoice may provide alternative costs, such as costs for screen protectors that are thicker than the screen protector being sold by the retailer and/or costs for screen protectors that are thinner than the screen protector being sold by the retailer. The invoice may be provided via a display (e.g., via electronic controlling device) and/or the invoice may be sent to one or parties (e.g., retailers, accountants, consumers). For example, the invoice may be electronically sent (e.g., via email and/or SMS message) to a retailer that has sold the screen protector to a consumer.

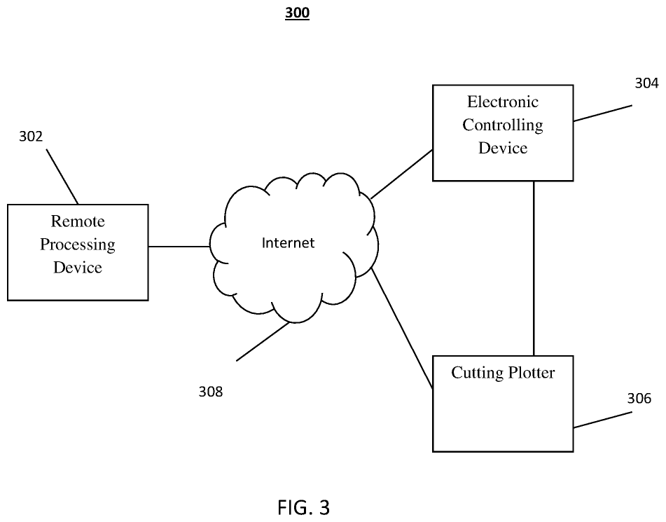

FIG. 3 shows an example system 300 including electronic controlling device 304 and cutting plotter 306, as described herein. As can be seen in FIG. 3, electronic controlling device 304 and cutting plotter 306 may directly communicate with one another. Also, or alternatively, electronic controlling device 304 and cutting plotter 306 may communicate with one another via Internet 308. Further, electronic controlling device 304 and cutting plotter 306 may communicate with remote processing device 302. Remote processing device 302, electronic controlling device 304, and cutting plotter 306 may include one or more processors, memories, software, and/or input devices. In an example, a lessor may use remote processing device 302 (e.g., software resident on remote processing device 302) to update and/or communicate the pricing structure for one or more cuts, to determine costs of the screen protector (including the costs of cuts of the screen protector), to generate and/or send invoices, etc., as described herein.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

What is claimed is:

1. A method comprising:
receiving a sheet into a cutting device, the cutting device configured to provide different cut types, and the sheet comprising an adhesive layer and at least one other layer;
determining a characteristic of the sheet received into the cutting device;
determining, based on the determined characteristic of the sheet, a cut type from among the different cut types;
cutting the sheet according to the determined cut type to form a screen protector; and
determining a charge for the cutting of the sheet based on the determined cut type.

2. The method of claim 1 wherein the characteristic of the sheet is at least one of a type, a thickness, a hardness, or a composition of the sheet.

3. The method of claim 1 wherein the adhesive layer of the sheet is formed of an acrylic material.

4. The method of claim 1 wherein the cutting of the sheet is performed mechanically.

5. The method of claim 1 wherein the cutting of the sheet is not performed by a laser.

6. The method of claim 1 wherein the characteristic of the sheet is determined by the cutting device.

7. The method of claim 1 wherein the sheet comprises a bottom layer located above the adhesive layer, the bottom layer being thinner than the adhesive layer.

8. The method of claim 7 wherein the bottom layer is about 3 mils thick.

9. The method of claim 1 wherein the adhesive is a non-self-wetting adhesive.

10. The method of claim 1 wherein the cutting device provides at least two types of cuts, and the type of cut used for the cutting of the sheet is based on the thickness of the sheet or an attribute of a composition of the sheet.

11. The method of claim 1 wherein the cutting device prevents users from altering the cutting device to perform a cut type that is different than the determined cut type.

12. A system comprising:
a cutting device configured to receive a sheet and to provide different cut types, wherein the received sheet comprises an adhesive layer and at least one other layer;
one or more processors configured to:
determine a characteristic of the sheet received into the cutting device;
determine, based on the determined characteristic of the sheet, a cut type from among the different cut types;
instruct the cutting device to cut the sheet according to the determined cut type to form a screen protector; and
determine a charge for the cutting of the sheet based on the determined cut type.

13. The system of claim 12 wherein at least one of the one or more processors forms part of the cutting device.

14. The system of claim 12 wherein at least one of the one or more processors forms part of a remote processing device.

15. The system of claim 12 wherein the determination of the characteristic of the sheet received into the cutting device is carried out by either:
a user providing characteristic information to the cutting device via a user interface;
a sensor of the cutting device sensing an indicia of the sheet that is indicative of the characteristic of the sheet; or
a sensor of the cutting device enabling a measurement of a thickness of the sheet.

16. The system of claim 12 wherein the characteristic of the sheet is at least one of a type, a thickness, a hardness, or a composition of the sheet.

17. The system of claim 12 wherein the adhesive is a non-self-wetting adhesive.

18. The system of claim 12 wherein the cutting device provides at least two types of cuts, and the type of cut used for the cutting of the sheet is based on the thickness of the sheet or an attribute of a composition of the sheet.

19. The system of claim 12 wherein the cutting device prevents users from altering the cutting device to perform a cut type that is different than the determined cut type.

20. A non-transitory computer-readable storage medium encoded with instructions which, when executed on a processor, perform a method of:
determining a characteristic of a sheet received into a cutting device, the cutting device configured to provide different cut types, and the sheet comprising an adhesive layer and at least one other layer;
determining, based on the determined characteristic of the sheet, a cut type from among the different cut types;
cutting the sheet according to the determined cut type to form a screen protector; and
determining a charge for the cutting of the sheet based on the determined cut type.
